(19) United States
(12) Patent Application Publication
(10) Pub. No.: US 2026/0252270 A1
(43) Pub. Date: Aug. 27, 2026

(54) DATA STORAGE APPARATUS FOR PENDING AND PROCESSING READ COMMAND BASED ON PROCESSING STATUS OF WRITE COMMAND, OPERATING METHOD THEREOF, AND MEMORY CONTROLLER THEREFOR

(71) Applicant: SK hynix Inc., Gyeonggi-do (KR)

(72) Inventors: Jae Youn JANG, Gyeonggi-do (KR); Ki Tae KIM, Gyeonggi-do (KR); Young Ho AHN, Gyeonggi-do (KR)

(21) Appl. No.: 19/278,788

(22) Filed: Jul. 24, 2025

(30) Foreign Application Priority Data
Feb. 24, 2025 (KR) 10-2025-0023508

(51) Int. Cl. G06F 3/06

(52) U.S. Cl. CPC G06F 3/0659; G06F 3/0604; G06F 3/0656; G06F 3/0679

(57) ABSTRACT

A data storage apparatus includes a storage medium and a memory controller. The memory controller is configured to determine, when a read address in which a first read command is to be performed at least partially matches a write address of a first write command being executed, whether or not to allow the first read command to pend based on a flag set corresponding to the first write command, store a pending first read command in a read ready queue, and control a command queued in the read ready queue to be processed after execution of the first write command is completed.

### CROSS-REFERENCES TO RELATED APPLICATION

The present application claims priority under 35 U.S.C. § 119(a) to Korean Patent Application Number 10-2025-0023508, filed on Feb. 24, 2025, which is incorporated herein by reference in its entirety.

### BACKGROUND

### 1. Technical Field

Various embodiments of the present disclosure may generally relate to a semiconductor integrated apparatus, and more particularly, to a data storage apparatus for pending and processing a read command based on a processing status of a write command, an operating method thereof, and a memory controller therefor.

### 2. Related Art

A data storage apparatus may store data in a memory device or read data stored in the memory device and provide the read data to the external apparatus, in response to a request of the external apparatus.

The performance of the data storage apparatus may depend on the data write/read speed of the memory device as well as the technique in which a memory controller operates the memory device.

Accordingly, there is a need for a technology for more efficiently writing or reading data in response to a request from an external apparatus.

### SUMMARY

Embodiments of the present disclosure provide a data storage apparatus capable of efficiently processing a read request for data being written to maintain data consistency, an operating method thereof, and a memory controller therefor.

In an embodiment of the present disclosure, a data storage apparatus may include a storage medium; and a memory controller. The memory controller may be configured to determine, when a read address of a first read command to be performed at least partially matches a write address of a first write command being currently executed, whether to pend the first read command based on a flag set corresponding to the first write command, store the pending first read command in a read ready queue, and process a command queued in the read ready queue after execution of the first write command is completed. The flag is configured to indicate that first write data associated with the first write command is flushed from a buffer memory device to the storage medium or remains in the buffer memory device.

In an embodiment of the present disclosure, a memory controller may be configured to receive a first write command, a first write address and first write data, store the first write data in a buffer memory device to set a flag to a first state. The memory controller may be further configured to transmit the first write data from the buffer memory device to a storage medium to set the flag to a second state. The memory controller may be further configured to determine, when a read address of a first read command received during current execution of the first write command at least partially matches the first write address, whether to pend the first read command based on the flag, and store the pending first read command in a read ready queue.

In an embodiment of the present disclosure, an operating method of a data storage apparatus may include a memory controller configured to determining, by a memory controller, when a read address of a first read command to be performed at least partially matches a write address of a first write command being currently executed, whether to pend the first read command based on a flag set corresponding to the first write command. The method may further include the memory controller storing, by the memory controller, the pending first read command in a read ready queue. The method may further include the memory controller processing, by the memory controller, a command queued in the read ready queue after execution of the first write command is completed. The flag may be configured to indicate that first write data associated with the first write command is flushed from a buffer memory device to a storage medium or remains in the buffer memory device.

According to the present technology, a read request may be held pending while read-requested data is written during a write operation, and the pending read request may be preferentially processed after the write operation is completed.

Accordingly, while advancing a timing of releasing data from a write buffer, the read request processing speed may be guaranteed.

These and other advantages, features, aspects, and embodiments are described in more detail below.

### BRIEF DESCRIPTION OF THE DRAWINGS

The above and other aspects, features and advantages of the subject matter of the present disclosure will be more clearly understood from the following detailed description taken in conjunction with the accompanying drawings, in which:

FIG. 1 is a diagram illustrating a configuration of a data processing system according to an embodiment of the present disclosure;

FIG. 2 is a diagram illustrating a configuration of a memory controller according to an embodiment of the present disclosure;

FIG. 3 is a diagram for describing a buffer memory device according to an embodiment of the present disclosure;

FIG. 4 is a diagram for describing a read ready queue according to an embodiment of the present disclosure;

FIG. 5 is a diagram for describing a write descriptor according to an embodiment of the present disclosure;

FIG. 6 is a diagram for describing a read descriptor according to an embodiment of the present disclosure;

FIG. 7 is a diagram for describing a write operation method of a data storage apparatus according to an embodiment of the present disclosure;

FIG. 8 is a diagram for describing an operating method of a data storage apparatus according to an embodiment of the present disclosure;

FIG. 9 is a diagram for describing an operating method of a data storage apparatus according to an embodiment of the present disclosure; and

FIG. 10 is a diagram for describing an operating method of a data storage apparatus according to an embodiment of the present disclosure.

### DETAILED DESCRIPTION

Various embodiments of the present disclosure are described in detail with reference to the accompanying drawings. The drawings are schematic illustrations of various embodiments and intermediate structures. As such, variations from the configurations and shapes of the illustrations as a result, for example, of manufacturing techniques and/or tolerances, are to be expected. Thus, the described embodiments should not be construed as being limited to the particular configurations and shapes illustrated herein but may include deviations in configurations and shapes which do not depart from the spirit and scope of the present disclosure as defined in the appended claims.

The embodiments of the present disclosure are described herein with reference to cross-section and/or plan illustrations of the embodiments. However, the embodiments should not be construed as limiting the scope of the present disclosure. Although a few embodiments of the present disclosure are shown and described, it will be appreciated by those of ordinary skill in the art that changes may be made in these embodiments without departing from the principles and spirit of the present disclosure.

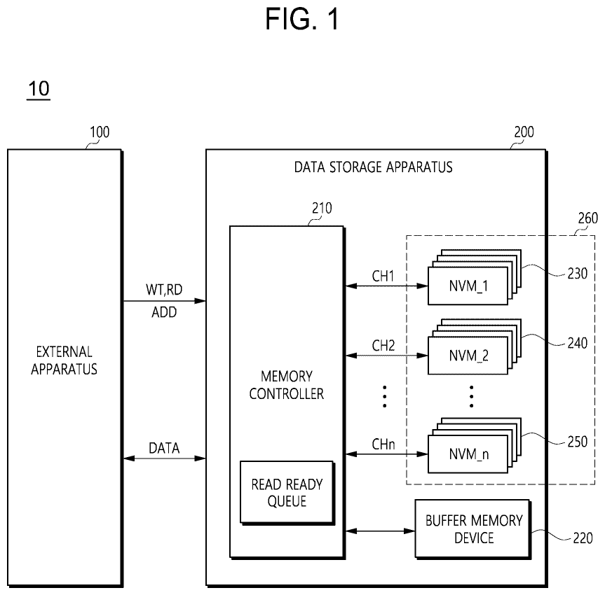

FIG. 1 is a diagram illustrating a configuration of a data processing system according to an embodiment of the present disclosure.

Referring to FIG. 1, a data processing system 10 includes an external apparatus 100 and a data storage apparatus 200.

The external apparatus 100 may include at least one processor. The external apparatus 100 may be a processor itself or an electronic device or system including a processor. The external apparatus 100 may operate as a host apparatus for the data storage apparatus 200.

The data storage apparatus 200 includes a memory controller 210, a buffer memory device 220, and a storage medium 260. The storage medium 260 includes at least a plurality of nonvolatile memory devices (NVM1, NMV2, . . . , NVMn) 230, 240, and 250 electrically coupled to the memory controller 210 through at least one channel CH1, CH2, . . . , CHn.

The external apparatus 100 may transmit a write request including a write command WT, an address ADD, and write data DATA to the data storage apparatus 200 to write data. In response to the write request, the data storage apparatus 200 may control the write data to be programmed in the storage medium 260.

The external apparatus 100 may transmit a read request including a read command RD and an address ADD to the data storage apparatus 200 to read data. The data storage apparatus 200 may read the read-requested data DATA from the storage medium 260 or the buffer memory device 220 and transmit the read data DATA to the external apparatus 100.

The data storage apparatus 200 may internally generate a read command or a write command to perform an internal management operation for managing the storage medium 260 and read or write data from or in the storage medium 260 according to the read command or the write command. The internal management operation may include a house keeping operation which is performed regardless of a request of the external apparatus 100 so as to efficiently use a storage space of the storage medium 260 or ensure the reliability of data stored in the storage medium 260, for example, a wear leveling operation, a garbage collection operation, a read reclaim operation, and the like.

In an embodiment, the storage medium 260 may include at least one of various types of nonvolatile memory devices 230 to 250 such as a NAND flash memory device, a NOR flash memory device, a ferroelectric RAM (FRAM) using a ferroelectric capacitor, a magnetic RAM (MRAM) using a tunneling magneto-resistive (TMR) layer, a phase-change RAM (PRAM) using a chalcogenide alloy, and a resistive RAM (RERAM) using a transition metal oxide.

Each of the nonvolatile memory devices 230 to 250 may include a plurality of memory cells. Each of the memory cells may operate as a single level cell (SLC) which stores 1-bit data or a multi-level cell (MLC) which stores 2-bit or more data. Portions of the nonvolatile memory devices 230 to 250 may be configured to operate as SLC memory devices, and the remaining nonvolatile memory devices may be configured to operate as MLC memory devices. Portions of the memory cells in each of the nonvolatile memory devices 230 to 250 may operate as SLCs, and the remaining memory cells in each of the nonvolatile memory devices 230 to 250 may operate as MLCs.

The buffer memory device 220 may temporarily store data transmitted and received between the external apparatus 100 and the data storage apparatus 200 in a read or write operation. In some embodiments, the buffer memory device 220 may be included in the inside or outside of the memory controller 210.

The buffer memory device 220 may temporarily store system data, for example, a descriptor related to a request of the external apparatus 100, mapdata for data stored in the storage medium 260, and the like. In some embodiments, the data storage apparatus 200 may be a DRAM-less apparatus and may not include the buffer memory device 220. In this case, the system data may be stored in a memory within the memory controller 210 or a memory of the external apparatus 100.

The descriptor may be a statement of works which includes information required for processing a request received from the external apparatus 100 through the memory controller 210.

The mapdata may be a collection of mapping information between an address (physical address) of a physical storage space constituting the storage medium 260 and a logical address assigned to the storage medium 260 by the external apparatus 100. The mapdata may be stored in the storage medium 260, and the memory controller 210 may at least partially load and use the mapdata required for the operation of the data storage apparatus 200 to the buffer memory device 220 or an internal memory (not shown) of the memory controller 210.

To perform the write operation according to the write request of the external apparatus 100, the memory controller 210 may generate the write descriptor to manage the write command and the write data. In an embodiment, the memory controller 210 may manage whether or not the write data related to the write operation being executed is released from the buffer memory device 220 through the write descriptor.

When an address included in the read request of the external apparatus 100 is associated with the write request being executed, the memory controller 210 may read data from the buffer memory device 220 or the storage medium 260 according to whether or not the write data is released from the buffer memory device 220 and provide the read data to the external apparatus 100.

In an embodiment, when the address included in the read request is associated with the write request being executed and the write data related to the write request is released from the buffer memory device 220, the memory controller 210 may store a read command included in the read request in a read ready queue READ READY QUEUE of the buffer memory device 220. When the write operation being executed is completed, the memory controller 210 may control the read command in the read ready queue READ READY QUEUE to be preferentially processed.

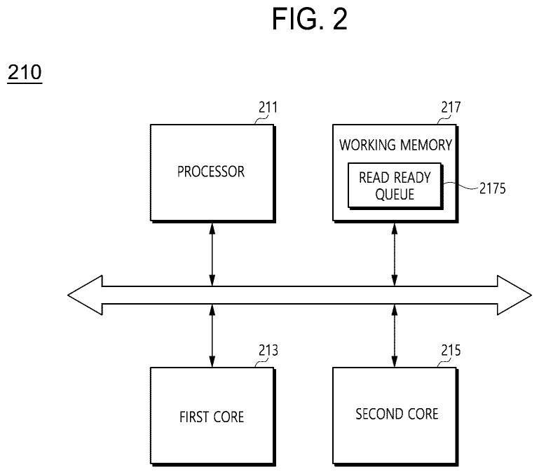

Described in detail with reference to FIGS. 2 to 10 will be the concept that a read request, which is associated with a write address of a write request currently processed, is held pending and then processed after completion of the process of the write request.

FIG. 2 is a configuration diagram of a memory controller according to an embodiment of the present disclosure.

Referring to FIG. 2, the memory controller 210 according to an embodiment includes a processor 211, a first core 213, a second core 215 and a working memory 217.

The processor 211 may be configured to execute firmware or software provided for various operations of the memory controller 210 on hardware to operate. The processor 211 may be configured in a combined form of hardware and firmware or software which operates on the hardware. The processor 211 may perform a function of a flash translation layer FTL, which manages the data storage apparatus 200, and the like.

The first core 213 may receive a command and a clock signal from the external apparatus 100 and provide a communication channel for controlling data input and output according to control of the processor 211. The first core 213 may provide a physical connection between the external apparatus 100 and the data storage apparatus 200.

In an embodiment, the first core 213 may communicate with the external apparatus 100 based on an interface using at least one among various communication interfaces or standards such as a universal serial bus (USB) protocol, a multimedia card (MMC) protocol, a peripheral component interconnection (PCI) protocol, a PCI-express (PCI-E) protocol, an advanced technology attachment (ATA) protocol, a serial advanced technology attachment (SATA) protocol, a parallel advanced technology attachment (PATA) protocol, a small computer system interface (SCSI) protocol, an enhanced small disk interface (ESDI) protocol, an integrated drive electronics (IDE) protocol, a private protocol, a system management bus (SMBus) protocol, an inter-integrated circuit (I2C) protocol, and an improved inter-integrated circuit (I3C) protocol.

The first core 213 may interpret and store a command included in a request received from the external apparatus 100. In response to the write request of the external apparatus 100, the first core 213 may queue the write command included in the write request in the working memory 217 and generate the write descriptor according to control of the processor 211. The first core 213 may store the write descriptor and the write data in the buffer memory device 220. The write descriptor may include buffering status information indicating whether or not the write data related to the write request is stored in the buffer memory device 220.

In response to the read request from the external apparatus 100, the first core 213 may queue the read command in the working memory 217, generate the read descriptor, and store the read descriptor in the buffer memory device 220 according to control of the processor 211.

The second core 215 may provide a communication channel for signal transmission and reception between the memory controller 210 and the storage medium 260. The second core 215 may dequeue a command queued in the buffer memory device 220 and process the command based on a descriptor associated with the dequeued command.

When the dequeued command is the write command, the second core 215 may generate a program command based on the write descriptor generated in the first core 213 and provide the program command and the write data to the storage medium 260. After transmitting the write data to the storage medium 260, the second core 215 may release the write data from the buffer memory device 220, for example, allocation for a write data storage region of the buffer memory device 220 and change the buffering status information of the write descriptor.

When the dequeued command is the read command, the second core 215 may confirm whether or not an address included in the read request is associated with the write request being executed based on the read descriptor generated in the first core 213. When the address included in the read request is associated with the write request being executed and the write data is released from the buffer memory device 220, the second core 215 may assign an index to the read command and store the read command in a read ready queue 2175 of the working memory 217 so that the read operation may be suspended. When the write operation being executed is completed, the memory controller 210 may control the read command of the read ready queue 2175 to be preferentially processed. In an embodiment, the index assigned to the pending read command may be an address of the read ready queue 2175 in which the read command is to be stored.

The read request associated with the address of the write request being executed may be sequentially received plural times. The second core 215 may manage indexes of a plurality of read commands associated with the write request being executed in the read ready queue 2175 as a linked list.

The linked list may be a data structure which logically links data by the index (address) by storing one data together with a position of next data when storing the data.

The second core 215 may store the index of the read command held pending in relation to the write request being executed in the write descriptor as a read command list. The read command list may include a head index and a tail index of the pending read command stored in the read ready queue 2175 as the linked list.

When the write operation being executed is completed, the second core 215 may dequeue the read command stored in the read ready queue 2175 based on the read command list stored in the write descriptor, generate a read command, and provide the generated read command to the storage medium 260. The second core 215 may control the storage medium 260 to preferentially process the pending read command other than other commands.

When the processing of the pending read command is completed, the second core 215 may release the index allocated to the pending read command.

The working memory 217 may be configured of a random access memory device such as a dynamic random access memory (DRAM) or a static random access memory (SRAM), but is the embodiments are not limited thereto. The working memory 217 may cache data stored in the buffer memory device 220.

The working memory 217 may store the firmware driven by the processor 211. Further, the working memory 217 may store data required for driving the firmware, for example, metadata. The metadata may be stored in the storage medium 260, and the processor 211 may load and use the metadata required for the operation of the data storage apparatus 200 to the working memory 217.

The working memory 217 may operate as a buffer memory configured to store write data provided from the external apparatus 100 and read data read from the storage medium 260.

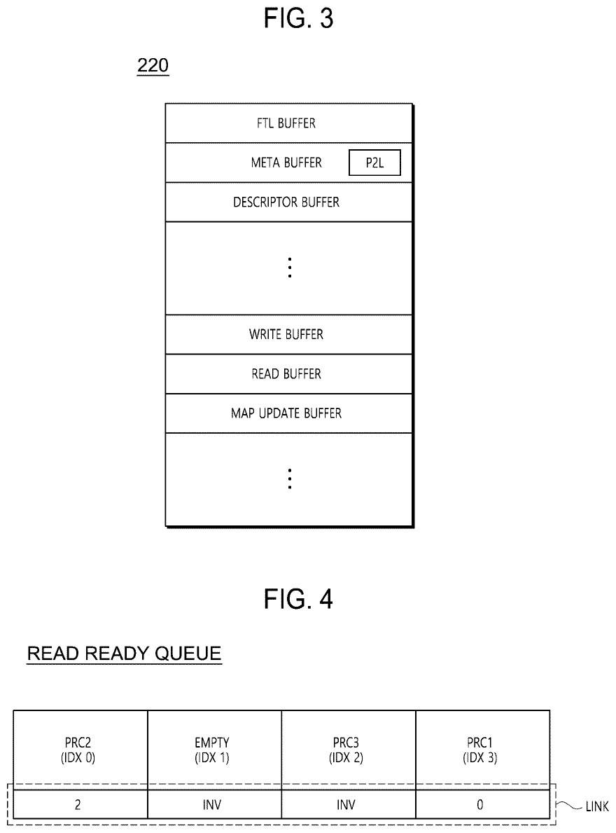

FIG. 3 is a diagram for describing a buffer memory device according to an embodiment of the present disclosure.

Referring to FIG. 3, the buffer memory device 220 according to an embodiment includes a flash translation layer (FTL) buffer FTL BUFFER in which the FTL is stored, a metadata buffer META BUFFER, a descriptor buffer DESCRIPTOR BUFFER, a write buffer WRITE BUFFER, a read buffer READ BUFFER and a map update buffer MAP UPDATE BUFFER.

The FTL may be software driven by the memory controller 210, and the memory controller 210 may drive the FTL to control a unique operation of the data storage apparatus 200 and provide apparatus compatibility to the external apparatus 100. Through the driving of the FTL, the external apparatus 100 may recognize and use the data storage apparatus 200 as a storage apparatus such as a disc.

The FTL may perform a read function, a write function, a garbage collection function, a wear-levelling function, a bad block management function, a mapping function, and the like. The FTL may be stored in a system region (not shown) of the storage medium 260, and when the data storage apparatus 200 is powered on, the FTL may be read from the system region of the storage medium 260 and loaded to the buffer memory device 220.

The FTL loaded to the buffer memory device 220 may be loaded to the working memory 217 of the memory controller 210.

Meta information such as a physical to logical (P2L) table may be stored in the metadata buffer META BUFFER.

Various descriptors generated for processing the request of the external apparatus 100, for example, the write descriptor and the read descriptor generated in the first core 213, and the like may be stored in the descriptor buffer DESCRIPTOR BUFFER.

The write data which is to be transmitted from the external apparatus 100 to the storage medium 260 may be temporarily stored in the write buffer WRITE BUFFER.

The read data which is read from the storage medium 260 and is to be transmitted to the external apparatus 100 may be temporarily stored in the read buffer READ BUFFER.

A map segment to be updated out of the mapping information may be temporarily stored in the map update buffer MAP UPDATE BUFFER.

The read command held pending in association with the address of the write request being executed may be queued in the read ready queue READ READY QUEUE. The index may be allocated to the pending read command, and the index may be an address of the read ready queue READ READY QUEUE in which the pending read command is to be queued. When a plurality of read requests associated with the address of one write request being executed are received and held pending, the index allocated to each of the pending read commands may be managed as the linked list according to the receiving order of the read commands.

FIG. 4 is a diagram for describing a read ready queue according to an embodiment of the present disclosure.

Referring to FIG. 4, first to third pending read commands PRC1, PRC2, and PRC3 are queued in the read ready queue READ READY QUEUE.

An index3 IDX3 is allocated to the first pending read command PRC1. It can be seen that zero (0) is stored in a linked list field LINK indicating a pending read command to be processed following the first pending read command PRC1. For example, a pending read command indicated by an index0 IDX0 may be processed following the first pending read command PRC1 indicated by the index3 IDX3.

Because ‘2’ is stored in the linked list field LINK of the second pending read command PRC2, to which the index0 IDX0 is allocated, a pending read command indicated by an index2 IDX2 may be processed following the second pending read command PRC2.

A linked list field LINK of the third pending read command PRC3 to which the index2 IDX2 is allocated may have an invalid value INV, and it may mean that no pending read command to be processed following the third pending read command PRC3 exists.

The first to third pending read commands PRC1, PRC2, and PRC3, which are queued in the read ready queue READ READY QUEUE in association with the address of the one write request being executed, may be read commands for the same address. When the processing of the write request being executed is completed, the second core 215 may dequeue the pending read commands, which are within a range between the head index and the tail index of the read command list confirmed from the write descriptor, from the read ready queue. The second core 215 may arbitrarily select a read command of the dequeued pending read commands and control the selected read command to be performed through the storage medium 260. The data read according to execution of the selected read command may be shared by all dequeued pending read commands PRC1, PRC2, and PRC3 so that execution for the pending read commands PRC1, PRC2, and PRC3 may be completed.

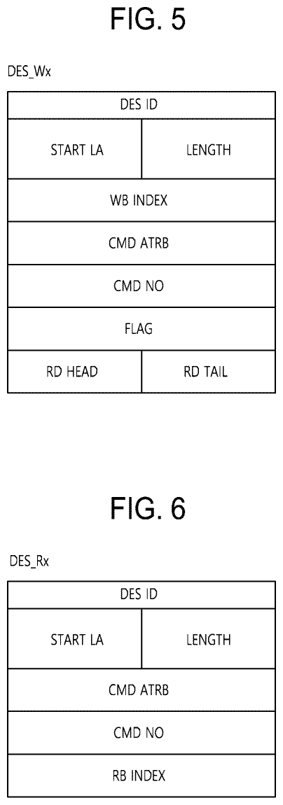

FIG. 5 is a diagram for describing a write descriptor according to an embodiment of the present disclosure.

Referring to FIG. 5, a write descriptor DES_Wx includes a write descriptor identifier field DES ID, an address field START LA and LENGTH, an index field WB INDEX, a command attribute field CMD ATRB, a command identifier field CMD NO, a flag field FLAG, and a read command list field RD HEAD and RD TAIL.

An address of the descriptor buffer DESCRIPTOR BUFFER in which the write descriptor DES_Wx is stored may be stored in the write descriptor identifier field DES ID.

Start logical address START LA and length LENGTH information related to the write command may be stored in the address field START LA and LENGTH.

First buffering information, which is an address of the write buffer WRITE BUFFER in which the write data is stored, may be stored in the index field WB INDEX.

A type of the command may be stored in the command attribute field CMD ATRB. In the write descriptor DES_Wx, a value indicating that the corresponding command is the write command may be stored in the command attribute field CMD ATRB.

An identification value for identifying the write command may be stored in the command identifier field CMD NO.

A value indicating whether or not the write data corresponding to the write descriptor DES_Wx is validly stored in the write buffer WRITE BUFFER or indicating whether or not the write data is transmitted to the storage medium 260 and allocation of the write buffer WRITE BUFFER is released may be stored in the flag field FLAG.

For example, when first write data WD1 is stored in the write buffer WRITE BUFFER, the first core 213 may set the flag field FLAG to a first state. For example, the first state of flag may indicate a status that the first write command is being dequeued and processed and the write data is maintained in the write buffer WRITE BUFFER.

The second core 215 may provide the program command and the first write data WD1 to the storage medium 260 and release the first write data WD1 from a region allocated for buffering the first write data WD1. The second core 215 may release the first write data WD1 from the buffering region of the first write data WD1 and then set the flag field FLAG to a second state. The second state of flag may indicate that transmission of the first write data WD1 to the storage medium 260 is completed. In another embodiment, the second state of flag may indicate that the first write data WD1 is released from the buffering region.

When a write command corresponding to the write descriptor DES_Wx is being executed, a head index RD HEAD and a tail index RD TAIL of a read command associated with an address START LA and LENGTH of the corresponding write command may be stored in the read command list field RD HEAD and RD TAIL.

For example, when a first read command for a first address is received during the execution of the first write command for the first address, an index L, where L is a natural number, may be allocated to the first read command and stored in the read ready queue READ READY QUEUE, and “L” as the head index RD HEAD may be stored in the read command list field of a first write descriptor DES_W1. When a read command for the first address is not received following the first read command, the same value as the head index RD HEAD may be stored in the tail index RD TAIL.

While the first write command is still executed, when the second read command for the first address is received following the first read command, an index M, where M is a natural number, may be allocated to the second read command. The first read command and the second read command may be configured as a linked list and then stored in the read ready queue READ READY QUEUE. For example, “M” may be stored in the linked list field of the first read command. In the read command list field of the first write descriptor DES_W1, “L” as the head index RD HEAD may be stored and “M” as the tail index RD TAIL may be stored.

Then, when a read command for the first address is not received following the second read command, the linked list field of the second read command in the read ready queue READ READY QUEUE may be set to the invalid value INV.

In an embodiment, the address field START LA and LENGTH, the index field WB INDEX, the command attribute field CMD ATRB, and the command identifier field CMD NO may be set by the first core 213, and the read command list field RD HEAD and RD TAIL may be set by the second core 215. The flag field FLAG may be set by the first core 213 and the second core 215.

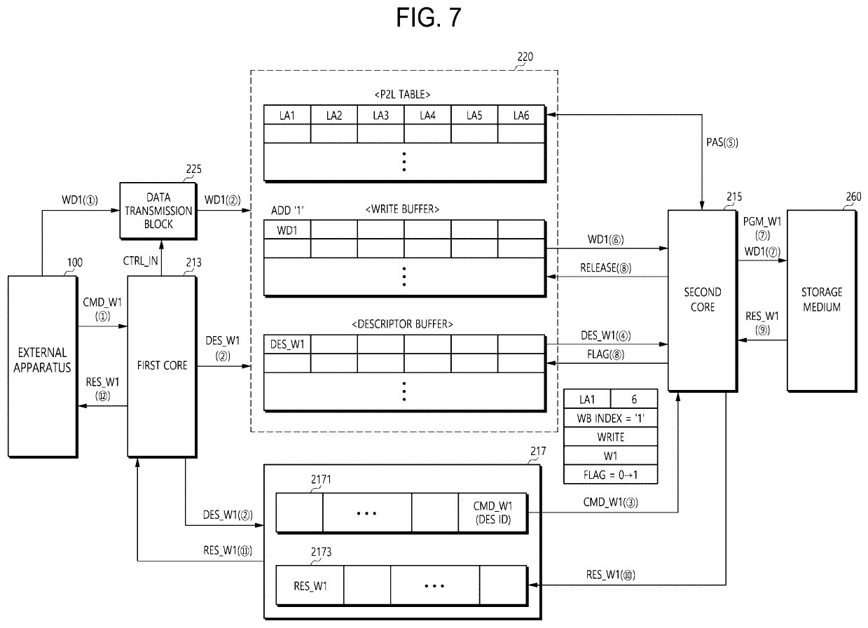

FIG. 6 is a diagram for describing a read descriptor according to an embodiment of the present disclosure.

Referring to FIG. 6, a read descriptor DES_Rx includes a read descriptor identifier field DES ID, an address field START LA and LENGTH, a command attribute field CMD ATRB, a command identifier field CMD NO, and an index field RB INDEX.

An address of the descriptor buffer DESCRIPTOR BUFFER in which the read descriptor DES_Rx is stored may be stored in the read descriptor identifier field DES ID.

Start logical address START LA and length LENGTH information related to the read command may be stored in the address field START LA and LENGTH.

A type of the command may be stored in the command attribute field CMD ATRB. In the read descriptor DES_Rx, a value indicating that the corresponding command is the read command may be stored in the command attribute field CMD ATRB.

An identification value for identifying the read command may be stored in the command identifier field CMD NO.

Second buffering information, which is an address of the read buffer READ BUFFER in which the read data is stored, may be stored in the index field RB INDEX.

FIG. 7 is a diagram for describing a write operation method of a data storage apparatus according to an embodiment of the present disclosure.

When the first write command CMD_W1 and the first write data WD1 are received from the external apparatus 100 (\textcircled{1}), the first core 213 may queue the received first write command CMD_W1 in a request queue 2171 of the working memory 217 (\textcircled{2}). The first core 213 may generate a first write descriptor DES_W1 based on the first write command CMD_W1 and store the first write descriptor DES_W1 in the descriptor buffer DESCRIPTOR BUFFER of the buffer memory device 220 (\textcircled{2}). Further, the first core 213 may store a write descriptor identifier DES ID, which is a storage position of the first write descriptor DES_W1, corresponding to the first write command CMD_W1 of the request queue 2171.

A data transmission block 225 may store the first write data WD1 received from the external apparatus 100 in the write buffer WRITE BUFFER of the buffer memory device 220 according to a control signal CTRL_IN provided from the first core 213 (\textcircled{2}). The data transmission block 225 may be included in the inside of the first core 213.

As the first write data WD1 is stored in the write buffer WRITE BUFFER, the first core 213 may store the first buffering information WB INDEX=‘1’, which is an address of the write buffer WRITE BUFFER in which the first write data WD1 is stored, in the index field WB INDEX of the first write descriptor DES_W1.

The first core 213 may set the flag field FLAG to the first state (logic “0”) to indicate a status that the first write data WD1 is validly being buffered in the write buffer WRITE BUFFER.

The second core 215 may periodically poll the request queue 2171 of the working memory 217. When the first core 213 queues the first write command CMD_W1 in the request queue 2171, the second core 215 may dequeue the first write command CDM_W1 from the request queue 2171 (\textcircled{3}). In dequeuing, the write descriptor identifier DES ID for the first write command CDM_W1 may be read.

The second core 215 may confirm that the command dequeued from the request queue 2171 is the write command, and access the descriptor buffer DESCRIPTOR BUFFER according to the descriptor identifier DES ID to read the first write descriptor DES_W1 (\textcircled{4}).

The second core 215 may interpret the first write descriptor DES_W1 and convert a logical address to be written to a physical address (\textcircled{5}). For example, when the start logical address START LA and length LENGTH information stored in the address field of the first write descriptor DES_W1 are ‘LA1’ and ‘6’, respectively, the second core 215 may sequentially store logical addresses ‘LA1 to LA6’ in the P2L table P2L TABLE of the buffer memory device 220, and thus convert the logical addresses ‘LA1 to LA6’ to the corresponding physical addresses PAs.

The second core 215 may access a position of the write buffer WRITE BUFFER corresponding to the first buffering information WB INDEX=‘1’ to read the first write data WD1 (\textcircled{6}), generate a first program command PGM_W1, and provide the first program command PGM_W1 and the first write data WD1 to the storage medium (\textcircled{7}).

The second core 215 may release allocation of the write buffer WRITE BUFFER for the first write data WD1 immediately after transmitting the first write data WD1 to the storage medium 260 (\textcircled{8}).

The second core 215 may set the flag field FLAG of the first write descriptor DES_W1, which is stored in the descriptor buffer DESCRIPTOR BUFFER, to the second state (logic “1”) to indicate that the first write data WD1 related to the first write command CMD_W1 is transmitted to the storage medium 260 (\textcircled{8}). The second state of flag may indicate a status that the first write data WD1 related to the first write command is released from the buffer allocation. For example, the second state of flag may indicate that data stored in a position corresponding to the first buffering information WB INDEX=‘1’ is invalidated.

The storage medium 260 may program the first write data WD1 based on the first program command PGM_W1 received from the second core 215 and provide a response signal RES_W1 including a program operation performing result to the second core 215 (\textcircled{9}).

The second core 215 may queue the response signal RES_W1 received from the storage medium 260 in a response queue 2173 of the working memory 217 (\textcircled{10}). The queued response signal RES_W1 may be transmitted to the external apparatus 100 through the first core 213 (\textcircled{11}, \textcircled{12}).

As the write operation is completed, the first core 213 may delete or invalidate the first write descriptor DES_W1.

As validity of the data stored in the write buffer is managed as the flag, when the read request associated with the address of the write command being executed is received, the processing of the read command may be suspended based on the flag until the write operation is completed.

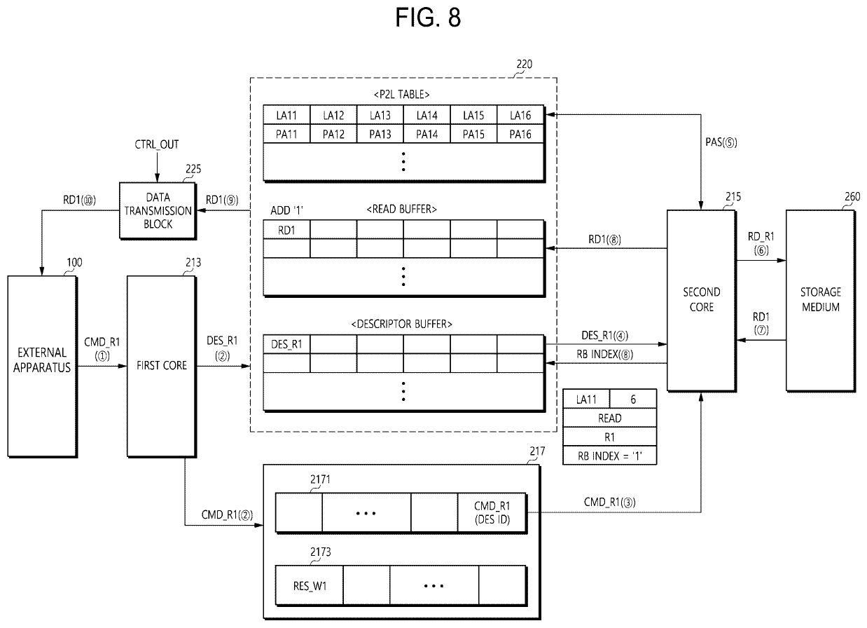

FIG. 8 is a diagram for describing an operating method of a data storage apparatus according to an embodiment of the present disclosure.

When a first read command CMD_R1 is received from the external apparatus 100 (\textcircled{1}), the first core 213 may queue the received first read command CMD_R1 in the request queue 2171 of the working memory 217 (\textcircled{2}). The first core 213 may generate a first read descriptor DES_R1 based on the first read command CMD_R1 and store the first read descriptor DES_R1 in the descriptor buffer DESCRIPTOR BUFFER of the buffer memory device 220 (\textcircled{2}). Further, the first core 213 may store the read descriptor identifier DES ID, which is a storage position of the first read descriptor DES_R1, corresponding to the first read command CMD_R1 of the request queue 2171.

The second core 215 may periodically poll the request queue 2171 of the working memory 217. When the first core 213 queues the first read command CMD_R1 in the request queue 2171, the second core 215 may dequeue the first read command CDM_R1 from the request queue 2171 (\textcircled{3}). In dequeuing, the read descriptor identifier DES ID for the first read command CDM_R1 may be read.

The second core 215 may confirm that the command dequeued from the request queue 2171 is the read command, and access the descriptor buffer DESCRIPTOR BUFFER according to the read descriptor identifier DES ID to read the first read descriptor DES_R1 (\textcircled{4}). The second core 215 may interpret the first read descriptor DES_R1 and confirm whether or not a logical address to be read is associated with a write logical address being currently executed.

For example, the second core 215 may inquire the descriptor buffer DESCRIPTOR BUFFER to confirm whether or not a write descriptor having logical addresses including at least a portion of logical addresses stored in the first read descriptor DES_R1 exists.

For example, when the start logical address START LA and length LENGTH information stored in the address field of the first read descriptor DES_R1 are ‘LA11’ and ‘6’, respectively, the second core 215 may confirm whether or not the write descriptor including at least a portion of the logical addresses ‘LA11’ to ‘LA16’ exists.

When the write descriptor for the logical addresses ‘LA11’ to ‘LA16’ does not exist, the second core 215 may acquire the physical addresses PAs corresponding to the read logical addresses from the P2L table P2L TABLE of the buffer memory device 220 (\textcircled{5}). For example, when the start logical address START LA and length LENGTH information stored in the address field of the first read descriptor DES_R1 are ‘LA11’ and ‘6’, respectively, the second core 215 may acquire the physical addresses PAs ‘PA11’ to ‘PA16’ corresponding to the read logical addresses ‘LA11’ to ‘LA16’ from the P2L table P2L TABLE of the buffer memory device 220.

The second core 215 may generate a first read command RD_R1 including the physical address PAs and provide the first read command RD_R1 to the storage medium 260 (\textcircled{6}).

The storage medium 260 may read first read data RD1 from a position corresponding to the physical address PAs and transmit the first read data RD1 to the second core 215 (\textcircled{7}). The second core 215 may store the first read data RD1 in the read buffer READ BUFFER (\textcircled{8}) and store an address (for example, ‘1’) of the read buffer READ BUFFER, in which the first read data RD1 is stored, in the index field RB INDEX of the first read descriptor DES_R1 (\textcircled{8}).

The data transmission block 225 may read the first read data RD1 stored in the read buffer READ BUFFER according to a control signal CTRL_OUT provided from the second core 215 (\textcircled{9}) and transmit the first read data RD1 to the external apparatus 100 (\textcircled{10}).

As described above, when the write request for the logical address related to the read command is not buffered, the read-requested data may be read from the storage medium 260.

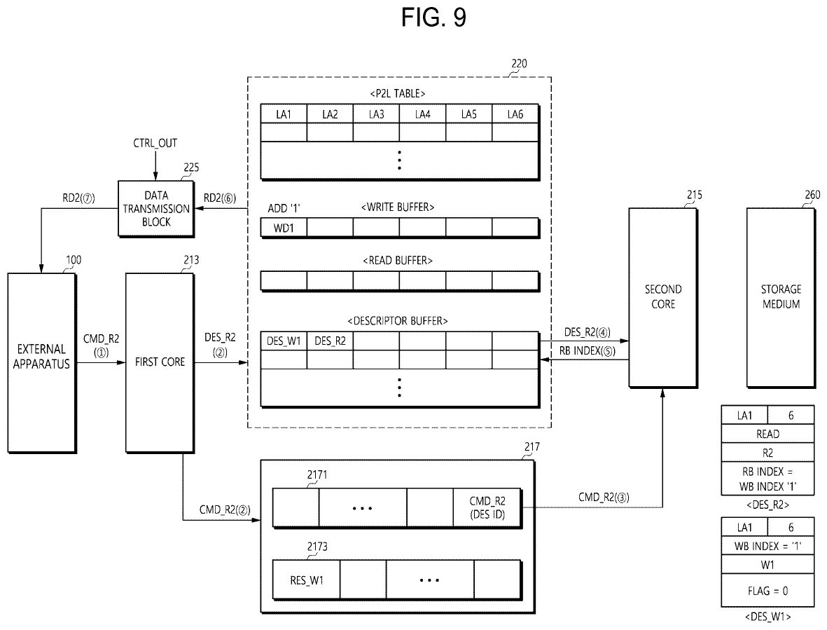

FIG. 9 is a diagram for describing an operating method of a data storage apparatus according to an embodiment of the present disclosure.

When a second read command CMD_R2 is received from the external apparatus 100 (\textcircled{1}), the first core 213 may queue the received second read command CMD_R2 in the request queue 2171 of the working memory 217 (\textcircled{2}). The first core 213 may generate a second read descriptor DES_R2 based on the second read command CMD_R2 and store the second read descriptor DES_R2 in the descriptor buffer DESCRIPTOR BUFFER of the buffer memory device 220 (\textcircled{2}). Further, the first core 213 may store a read descriptor identifier DES ID, which is a storage position of the second read descriptor DES_R2, corresponding to the second read command CMD_R2 of the request queue 2171.

The second core 215 may periodically poll the request queue 2171 of the working memory 217 to dequeue the second read command CDM_R2 from the request queue 2171 (\textcircled{3}). In dequeuing, the read descriptor identifier DES ID for the second read command CDM_R2 may be read.

The second core 215 may confirm that the command dequeued from the request queue 2171 is the read command, and access the descriptor buffer DESCRIPTOR BUFFER according to the read descriptor identifier DES ID to read the second read descriptor DES_R2 (\textcircled{4}). The second core 215 may interpret the second read descriptor DES_R2 and confirm whether or not the logical address to be read is associated with the write logical address being currently executed.

For example, the second core 215 may inquire the descriptor buffer DESCRIPTOR BUFFER to confirm whether or not a write descriptor having logical addresses including at least a portion of logical addresses of the second read descriptor DES_R2 exists.

For example, when the start logical address START LA and length LENGTH information stored in the address field of the second read descriptor DES_R2 are ‘LA1’ and ‘6’, respectively, the second core 215 may confirm whether or not the write descriptor including at least a portion of the logical addresses ‘LA1’ to ‘LA6’ exists.

When the first write descriptor DES_W1 is stored in the descriptor buffer DESCRIPTOR BUFFER and the start logical address START LA and length LENGTH information stored in the address field of the first write descriptor DES_W1 are ‘LA1’ and ‘6’, respectively, the second core 215 may determine that the write operation related to the read logical addresses ‘LA1’ to ‘LA6’ is being executed.

The second core 215 may confirm the flag field FLAG of the first write descriptor DES_W1 to determine whether or not the first write data WD1 is being buffered in the write buffer WRITE BUFFER. For example, when the flag field FLAG is set in the first state (logic “0”), the second core 215 may determine that the first write data WD1 is validly buffered in the write buffer WRITE BUFFER.

Without transmission of the second read command CMD_R2 to the storage medium 260, the second core 215 may store, in the index field RB INDEX of the second read descriptor DES_R2, an address of the read buffer READ BUFFER in which the second read data RD2 is stored, for example, an address (for example, WB INDEX=‘1’) in which the first write data WD1 is stored (\textcircled{5}).

The data transmission block 225 may read the second read data RD2 stored in the write buffer WRITE BUFFER according to the control signal CTRL_OUT provided from the second core 215 (\textcircled{6}) and transmit the second read data RD2 to the external apparatus 100 (\textcircled{7}).

As described above, when the write command and the write data for the logical address related to the read command are buffered, the write data buffered in the buffer memory device 220 may be provided as the read data without access to the storage medium 260.

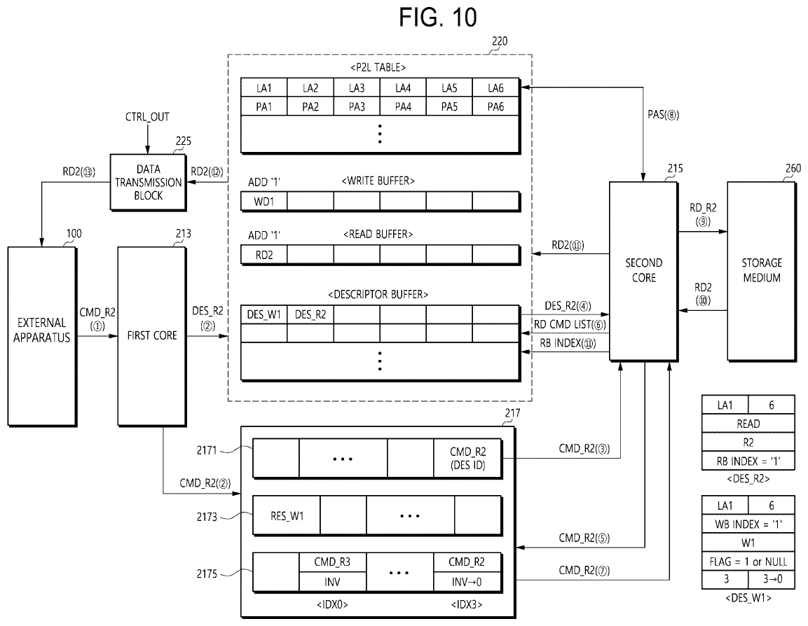

FIG. 10 is a diagram for describing an operating method of a data storage apparatus according to an embodiment of the present disclosure.

Referring to FIG. 10, when the second read command CMD_R2 is received from the external apparatus 100 (\textcircled{1}), the first core 213 may queue the received second read command CMD_R2 in a request queue 2171 of the working memory 217 (\textcircled{2}). The first core 213 may generate the second read descriptor DES_R2 based on the second read command CMD_R2 and store the second read descriptor DES_R2 in the descriptor buffer DESCRIPTOR BUFFER of the buffer memory device 220 (\textcircled{2}). Further, the first core 213 may store a read descriptor identifier DES ID, which is a storage position of the second read descriptor DES_R2, corresponding to the second read command CMD_R2 of the request queue 2171.

The second core 215 may periodically poll the request queue 2171 of the working memory 217 to dequeue the second read command CDM_R2 from the request queue 2171 (\textcircled{3}). In dequeuing, the read descriptor identifier DES ID for the second read command CDM_R2 may be read.

The second core 215 may confirm that the command dequeued from the request queue 2171 is the read command, and access the descriptor buffer DESCRIPTOR BUFFER according to the read descriptor identifier DES ID to read the second read descriptor DES_R2 (\textcircled{4}). The second core 215 may interpret the second read descriptor DES_R2 and confirm whether or not the logical address to be read is associated with the write logical address being currently executed.

For example, the second core 215 may inquire the descriptor buffer DESCRIPTOR BUFFER to confirm whether or not a write descriptor having logical addresses including at least a portion of logical addresses of the second read descriptor DES_R2 exists.

For example, when the start logical address START LA and length LENGTH information stored in the address field of the second read descriptor DES_R2 are ‘LA1’ and ‘6’, respectively, the second core 215 may confirm whether or not the write descriptor including at least a portion of the logical addresses ‘LA1’ to ‘LA6’ exists.

When the first write descriptor DES_W1 is stored in the descriptor buffer DESCRIPTOR BUFFER and the start logical address START LA and length LENGTH information stored in the address field of the first write descriptor DES_W1 are ‘LA1’ and ‘6’, respectively, the second core 215 may determine that the write operation related to the read logical addresses ‘LA1’ to ‘LA6’ is being executed.

The second core 215 may confirm the flag field FLAG of the first write descriptor DES_W1 to determine whether or not the first write data WD1 is being buffered in the write buffer WRITE BUFFER. For example, when the flag field FLAG is set in the second state (logic “1”) or NULL, the second core 215 may determine that the first write data WD1 is not buffered in the write buffer WRITE BUFFER. The second state of flag may indicate that transmission of the first write data WD1 to the storage medium 260 is completed. In another embodiment, the second state of flag may indicate that the buffering of the first write data WD1 is released.

When the first write data WD1 is not buffered in the write buffer WRITE BUFFER, the second core 215 may assign an index to the second read command CMD_R2 and store the second read command CMD_R2 in the read ready queue 2175 of the working memory 217 so that the processing of the second read command CMD_R2 may be suspended (\textcircled{5}). In an embodiment, the index assigned to the pending second read command CMD_R2 may be an address of a read ready queue 2175, in which the second read command CMD_R2 is stored. FIG. 10 illustrates that an index 3 IDX3 is assigned to the second read command CMD_R2.

The read request associated with the address of the write request being executed may be sequentially received plural times. The second core 215 may manage indexes of a plurality of read commands associated with the write request being executed in the read ready queue 2175 as a linked list.

When a read command for the same logical address is not received following the second read command CMD_R2, a link value of the second read command CMD_R2 stored in the read ready queue 2175 may be the invalid value INV.

The second core 215 may store the index of the read command held pending in relation with the first write command CMD_W1 being executed in the write descriptor as a read command list (\textcircled{6}). The read command list may include a head index and a tail index of the pending read command stored in the read ready queue 2175 as the linked list. When the pending read command is one, the same value as the head index may be stored in the tail index of the read command list. Referring to FIG. 10, it can be seen that ‘3’ is stored in the head index and the tail index of the read command list of the first write descriptor DES_W1.

The third read command CMD_R3 for the same logical address may be received following the second read command CMD_R2. When the flag field FLAG of the first write descriptor DES_W1 is set in the second state (logic “1”) or NULL, the second core 215 may assign an index (for example, ‘0’) to the third read command CMD_R3 and store the third read command CMD_R3 in the read ready queue 2175 so that the processing of the third read command CMD_R3 may be suspended. The link value of the second read command CMD_R2 stored in the read ready queue 2175 may be changed to the index (for example, ‘0’) assigned to the third read command CMD_R3 and the link value of the third read command CMD_R3 may be set to the invalid value INV.

The value of the tail index of the read command list of the first write descriptor DES_W1 may be changed from ‘3’ to ‘0’ because of the third read command CMD_R3 having the index ‘0’.

When the processing of the first write command CMD_W1 is completed, the second core 215 may dequeue the read command stored in the read ready queue 2175 based on the read command list stored in the write descriptor (\textcircled{7}) and control the storage medium 260 to preferentially process the dequeued read command other than other commands.

The second core 215 may acquire the physical address PAs corresponding to the read logical address from the P2L table P2L TABLE of the buffer memory device 220 (\textcircled{8}). For example, when the start logical address START LA and length LENGTH information stored in the address field of the second read descriptor DES_R2 are ‘LA1’ and ‘6’, respectively, the second core 215 may acquire the physical addresses (PAs) ‘PA1’ to ‘PA6’ corresponding to the read logical addresses ‘LA1’ to ‘LA6’ from the P2L table P2L Table of the buffer memory device 220.

The second core 215 may generate the second read command RD_R2 including the physical address PAs and provide the second read command RD_R2 to the storage medium 260 (\textcircled{9}).

The storage medium 260 may read the second read data RD2 from a position corresponding to the physical address PAs and transmit the second read data RD2 to the second core 215 (\textcircled{10}). The second core 215 may store the second read data RD2 in the read buffer READ BUFFER (\textcircled{11}) and store an address (for example, ‘1’) of the read buffer READ BUFFER, in which the second read data RD2 is stored, in the index field RB INDEX of the second read descriptor DES_R2 (\textcircled{11}).

The data transmission block 225 may read the second read data RD2 stored in the read buffer READ BUFFER according to the control signal CTRL_OUT provided from the second core 215 (\textcircled{12}) and transmit the second read data RD2 to the external apparatus 100 (\textcircled{13}).

The second read data RD2 may be shared by the third read command CMD_RD3 so that an undesired access to the storage medium 260 may be prevented.

When the processing of the pending read command is completed, the second core 215 may release the index allocated to the pending read command.

As described, when the write command for the logical address related to the read command is not buffered, the read command may be held pending and when the processing of the write command is completed, the read-requested data may be read from the storage medium 260.

When the data storage apparatus operates as a fire & forget mode which release the write data from a buffer, in which the write data is stored, as soon as the write data buffered in the buffer memory device 220 is flushed to the storage medium 260, the data storage apparatus may manage whether or not the write data is buffered or flushed as the flag and provide the read data from the buffer memory device 220 or the storage medium 260.

Accordingly, while advancing the timing of releasing write data from the buffer memory device in the write operation, consistency between the write data and the read data may be endured.

The above described embodiments of the present disclosure are intended to illustrate and not to limit the scope of the present disclosure. Various alternatives and equivalents are possible. The invention is not limited by the embodiments described herein. Nor is the invention limited to any specific type of semiconductor device. Other additions, subtractions, or modifications to the embodiments which are apparent in view of the present disclosure are intended to fall within the scope of the appended claims. Furthermore, the embodiments may be combined to form additional embodiments.

What is claimed is:

1. A data storage apparatus comprising:
a storage medium; and
a memory controller configured to:
determine, when a read address of a first read command to be performed at least partially matches a write address of a first write command being currently executed, whether to pend the first read command based on a flag set corresponding to the first write command,
store the pending first read command in a read ready queue, and
process a command queued in the read ready queue after execution of the first write command is completed,
wherein the flag is configured to indicate that first write data associated with the first write command is flushed from a buffer memory device to the storage medium or remains in the buffer memory device.

2. The data storage apparatus of claim 1, wherein:
when the flag is in a first state, the memory controller is configured to read the first write data from the buffer memory device and output the first write data as read data corresponding to the first read command, and
the flag in the first state is configured to indicate a status that the first write data is stored in the buffer memory device.

3. The data storage apparatus of claim 1, wherein:
when the flag is in a second state, the memory controller is configured to read first read data from the storage medium and output the first read data as read data corresponding to the first read command, and
the flag in the second state is configured to indicate a status that the first write data is flushed from the buffer memory device to the storage medium.

4. The data storage apparatus of claim 1, wherein the memory controller is configured to allocate an index to the pending first read command and store the pending first read command in a region corresponding to the index within the read ready queue.

5. The data storage apparatus of claim 4, wherein the memory controller is configured to store, as a read command list, the index in a descriptor of the first write command.

6. The data storage apparatus of claim 1, wherein when a plurality of read commands, each of which includes a read address at least partially matching the write address, are sequentially received and held pending, the memory controller is configured to store, as a linked list, the plurality of read commands in the read ready queue.

7. The data storage apparatus of claim 6, wherein the memory controller is configured to allocate an index to each of the plurality of pending read commands and store the index as a link value according to a received order of the plurality of pending read commands to form the linked list.

8. The data storage apparatus of claim 7, wherein the memory controller is configured to store, as a read command list, a head index and a tail index of the linked list, which is stored in the read ready queue in relation to the first write command, in a descriptor of the first write command.

9. The data storage apparatus of claim 7, wherein after processing of the first write command is completed, the memory controller is configured to execute one of the plurality of pending read commands, which are stored in the read ready queue in relation to the first write command, to receive read data from the storage medium and control the read data to be shared by the plurality of pending read commands.

10. A memory controller configured to:
receive a first write command, a first write address and first write data,
store the first write data in a buffer memory device to set a flag to a first state,
transmit the first write data from the buffer memory device to a storage medium to set the flag to a second state,
determine, when a read address of a first read command received during current execution of the first write command at least partially matches the first write address, whether to pend the first read command based on the flag, and
store the pending first read command in a read ready queue.

11. The memory controller of claim 10, wherein the memory controller is configured to:
read, when the flag is in the first state, the first write data from the buffer memory device, and
output the first write data as read data corresponding to the first read command.

12. The memory controller of claim 10, wherein the memory controller is configured to:
read, when the flag is in the second state, first read data from the storage medium, and
output the first read data as read data corresponding to the first read command.

13. The memory controller of claim 10, wherein the memory controller is configured to:
allocate an index to the pending first read command, and
store the pending first read command in a region corresponding to the index within the read ready queue.

14. The memory controller of claim 13, wherein the memory controller is configured to store, as a read command list, the index in a descriptor of the first write command.

15. The memory controller of claim 10,
wherein the memory controller is configured to:
allocate, when a plurality of read commands, each of which includes a read address at least partially matching the first write address, are sequentially received and held pending, an index is allocated to each of the plurality of pending read commands, and
store, as a linked list, the index in the read ready queue, and
wherein the memory controller allocates the index as a link value according to a received order of the plurality of pending read commands.

16. The memory controller of claim 15, wherein the memory controller is configured to store, as a read command list, a head index and a tail index of the linked list, which is stored in the read ready queue in relation to the first write command, in a descriptor of the first write command.

17. An operation method of a data storage apparatus, the method comprising:
determining, by a memory controller, when a read address of a first read command to be performed at least partially matches a write address of a first write command being currently executed, whether to pend the first read command based on a flag set corresponding to the first write command;
storing, by the memory controller, the pending first read command in a read ready queue; and
processing, by the memory controller, a command queued in the read ready queue after execution of the first write command is completed,
wherein the flag is configured to indicate that first write data associated with the first write command is flushed from a buffer memory device to a storage medium or remains in the buffer memory device.

18. The method of claim 17,
further comprising, when the flag is in a first state, reading, by the memory controller, the first write data from the buffer memory device and outputting, by the memory controller, the first write data as read data corresponding to the first read command,
wherein the flag in the first state is configured to indicate a status that the first write data is stored in the buffer memory device.

19. The method of claim 17,
further comprising, when the flag is in a second state, reading, by the memory controller, first read data from the storage medium and outputting, by the memory controller, the first read data as read data corresponding to the first read command,
wherein the flag in the second state is configured to indicate a status that the first write data is flushed from the buffer memory device to the storage medium.

20. The method of claim 17, further comprising allocating, by the memory controller, an index to the pending first read command and storing, by the memory controller, the pending first read command in a region corresponding to the index within the read ready queue.

21. The method of claim 20, further comprising storing, by the memory controller, the index as a read command list in a descriptor of the first write command.

22. The method of claim 17, further comprising, when a plurality of read commands, each of which includes a read address at least partially matching the write address, are sequentially received and held pending, storing, by the memory controller, the plurality of read commands as a linked list in the read ready queue.

23. The method of claim 22, wherein storing the plurality of read commands as the linked list includes:
allocating an index to each of the plurality of pending read commands; and
storing the index as a link value according to a received order of the plurality of pending read commands to form the linked list.

24. The method of claim 23, further comprising storing, by the memory controller, a head index and a tail index of the linked list, which is stored in the read ready queue in relation to the first write command, as a read command list in a descriptor of the first write command.

25. The method of claim 23, further comprising, after processing of the first write command is completed, executing, by the memory controller, one of the plurality of pending read commands, which are stored in the read ready queue in relation to the first write command, to receive read data from the storage medium and controlling, by the memory controller, the read data to be shared by the plurality of pending read commands.
